(19) United States
(12) Patent Application Publication
(10) Pub. No.: US 2025/0243083 A1
(43) Pub. Date: Jul. 31, 2025

(54) COPPER-DOPED LITHIUM COBALT OXIDE PRECURSOR, POSITIVE ELECTRODE MATERIAL, AND PREPARATION METHOD THEREFOR AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/688,367

(22) PCT Filed: Sep. 20, 2022
(86) PCT No.: PCT/CN2022/119990

§ 371 Date: Mar. 1, 2024

(30) Foreign Application Priority Data
Jun. 27, 2022 (CN) 202210736773.0

(51) Int. Cl. C01G 51/42; H01M 10/0525

(52) U.S. Cl. CPC C01G 51/42; H01M 10/0525; C01P 2004/03; C01P 2006/40

(57) ABSTRACT

Disclosed are a copper-doped lithium cobalt oxide precursor, a cathode material, a preparation method therefor and use thereof. The method comprises the following steps: (1) mixing a solution of soluble cobalt salt and copper salt, urea and a carbon source to perform a hydrothermal reaction to obtain a mixture; and (2) subjecting the mixture obtained in step (1) to solid-liquid separation, washing and drying the obtained solid product to obtain the copper-doped lithium cobalt oxide precursor. The cathode material prepared by the copper-doped lithium cobalt oxide precursor has better cycle performance and discharge capacity.

### FIELD

The present disclosure belongs to the technical field of cathode materials for lithium batteries, and in particular relates to a copper-doped lithium cobalt oxide precursor, a cathode material, a preparation method therefor and use thereof.

### BACKGROUND

Lithium cobalt oxide is an early cathode material used in commercial lithium-ion batteries, and is mainly used in the manufacture of lithium-ion batteries for mobile phones, notebook computers and other portable electronic devices. The lithium cobalt oxide cathode material has the characteristics of wide range of applied voltage, easy synthesis, and fast charge and discharge. However, the existing lithium cobalt oxide materials have a series of problems at high voltages due to its own structure, such as poor charge-discharge cycles and poor storage performance under high temperature. When the traditional doping and coating methods are used to modify the lithium cobalt oxide materials, the improvement for the discharge capacity of lithium cobalt oxide materials is limited, which cannot meet the increasingly high requirements in the lithium battery industry.

### SUMMARY

The present invention aims to solve at least one of the technical problems existing in the prior art. Therefore, the present invention provides a copper-doped lithium cobalt oxide precursor, a cathode material, a preparation method therefor and use thereof, and the cathode material prepared by the copper-doped lithium cobalt oxide precursor has better cycle performance and discharge capacity.

The above-mentioned technical purpose of the present invention is achieved through the following technical solutions.

The present invention provides a method for preparing a copper-doped lithium cobalt oxide precursor, comprising the following steps:
(1) mixing a solution of soluble cobalt salt and copper salt, urea and a carbon source to perform a hydrothermal reaction to obtain a mixture; and
(2) subjecting the mixture obtained in step (1) to solid-liquid separation, washing and drying the obtained solid product to obtain the copper-doped lithium cobalt oxide precursor.

Preferably, a total concentration of metal ions in the solution of soluble cobalt salt and copper salt is 0.01-1.5 mol/L, and a molar ratio of cobalt element to copper element is 10:(0.01-2).

Further preferably, the total concentration of metal ions in the solution of soluble cobalt salt and copper salt is 0.05-1.0 mol/L, and the molar ratio of cobalt element to copper element is 10:(0.01-1).

Preferably, a concentration of the urea is 0.1-5.0 mol/L.

Further preferably, the concentration of the urea is 0.2-4.0 mol/L.

Preferably, a molar quantity of the carbon source is 1.5-6 times that of the copper element.

Further preferably, the molar quantity of the carbon source is 2-4 times that of the copper element.

Preferably, the carbon source is at least one selected from the group consisting of glucose, fructose, galactose, lactose and maltose.

Preferably, a temperature for the hydrothermal reaction in step (1) is 100-200° C., and a duration for the reaction is 1-10 h.

Further preferably, the temperature for the hydrothermal reaction in step (1) is 120-160° C., and the duration for the reaction is 4-8 h.

Preferably, the solution of soluble cobalt salt and copper salt is prepared from a soluble salt, and the soluble salt is at least one selected from the group consisting of sulfate salt and chloride salt.

Preferably, the washing in step (2) is washing the obtained product with ethanol first, and then with water.

Preferably, the drying in step (2) is drying the obtained product at 60-150° C. for 1-10 hours.

Further preferably, the drying in step (2) is drying the obtained product at 80-120° C. for 2-4 hours.

Preferably, the mixing in step (1) is first adding the solution of soluble cobalt salt and copper salt into a hydrothermal reaction kettle with an addition amount of ⅗-⅘ of the volume of the reaction kettle, and then adding the urea and the carbon source into the hydrothermal reaction kettle.

Preferably, during the hydrothermal reaction, the stirring speed in the reaction kettle is 100-500 r/min.

Further preferably, during the hydrothermal reaction, the stirring speed in the reaction kettle is 100-200 r/min.

A copper-doped lithium cobalt oxide precursor is prepared by the above-mentioned method.

A method for preparing a cathode material, comprises the following steps: mixing the above-mentioned lithium cobalt oxide precursor with a lithium source, and then calcining a resulting mixture to obtain the cathode material.

Preferably, the lithium source is at least one selected from the group consisting of lithium carbonate and lithium hydroxide.

Preferably, the calcining is conducted by first heating the resulting mixture under the protection of an inert gas with a heating rate of 3-15° C./min and a heating gradient from room temperature to 600-900° C., then introducing an oxidizing gas instead, and maintaining at 600-900° C. for 10-20 h.

Further preferably, the calcining is conducted by first heating the resulting mixture under the protection of an inert gas with a heating rate of 5-10° C./min and a heating gradient from room temperature to 700-850° C., then introducing an oxidizing gas instead, and maintaining at 700-850° C. for 12-18 h, wherein the room temperature refers to 25° C.

Preferably, a method for preparing a cathode material, comprises the following steps:
(1) according to the molar ratio of cobalt element to copper element of 10:(0.01-1), selecting a soluble salt as raw materials to prepare a solution of mixed salts with a total concentration of metal ions of 0.05-1.0 mol/L, wherein the soluble salt is at least one selected from the group consisting of sulfate salt and chloride salt;
(2) adding the solution of mixed salts in step (1) into a hydrothermal reaction kettle with an addition amount of ⅗-⅘ of the volume of the reaction kettle;
(3) adding urea to the reaction kettle with a concentration of 0.2-4.0 mol/L;
(4) adding a carbon source into the reaction kettle with a molar quantity of 2-4 times that of the copper element; the carbon source is at least one selected from the group consisting of glucose, fructose, galactose, lactose, and maltose;
(5) sealing the reaction kettle, heating and stirring the mixture at a heating temperature of 120-160° C. and a stirring speed of 100-200 r/min to react for 4-8 h;
(6) after the reaction is completed, subjecting the reaction mixture to solid-liquid separation, washing the obtained solid product with ethanol first, then with pure water, and then drying the washed product at 80-120° C. for 2-4 hours to obtain a copper-doped lithium cobalt oxide precursor; and
(7) according to the molar ratio of cobalt element to lithium element of 1:(1.2-1.4), mixing the precursor material with at least one of lithium carbonate and lithium hydroxide, then heating the mixture under an inert gas with a heating rate of 5-10° C./min and a heating gradient from room temperature to 700-850° C., then introducing air or oxygen instead, maintaining the temperature for 12-18 h, then crushing and sieving the resulting mixture, and removing iron from the mixture to obtain a cathode material of copper-doped lithium cobalt oxide.

The present invention provides a cathode material, which is prepared by the above-mentioned method.

Preferably, the discharge capacity of the cathode material is not lower than 219 mAh/g, for example, 219.4 mAh/g.

Preferably, the capacity retention rate after 600 cycles of the cathode material is not lower than 84%, for example, 84.6%.

The present invention provides use of the above-mentioned cathode material in lithium ion battery.

The beneficial effects of the present invention are as follows.

In the present invention, the cobalt-copper mixed salt, the urea and the carbon source are subjected to hydrothermal reaction in a reaction kettle to obtain a copper-doped lithium cobalt oxide precursor, which is then mixed and calcined with a lithium source to prepare a copper-doped cathode material. Since the copper-doped lithium cobalt oxide precursor is doped with copper element, when it is prepared into a cathode material, the discharge capacity and the cycle stability of the cathode material under high voltage can be further improved, so that the discharge capacity of the cathode material is 219.4 mAh/g or more, and the capacity retention rate after 600 cycles is 84.6% or more. The reaction principle thereof is as follows.

During the hydrothermal reaction:

CO(NH₂)₂+H₂O→2NH₃+CO₂,

NH₃·H₂O→NH₄⁺+OH⁻,

CO₂+H₂O→CO₃²⁻+2H⁺, and

Co²⁺+(1−0.5y)CO₃²⁻+yOH⁻→Co(OH)_{y}(CO₃)_{1-0.5y}, wherein y<2.

Copper ions are complexed with urea and reacted with a carbon source (such as glucose) in a redox reaction:

{Cu[CO(NH₂)₂]₄}²⁺+CH₂OH(CHOH)₄CHO→CH₂OH(CHOH)₄COOH+Cu₂O+2H₂O+4CO(NH₂)₂, and

CH₂OH(CHOH)₄COOH+NH₃·H₂O→CH₂OH(CHOH)₄COONH₄+H₂O.

During the hydrothermal reaction, the cuprous oxide precipitate is formed by the redox reaction between copper ions and carbohydrates, and the divalent cobalt ions are precipitated in the form of basic cobalt carbonate, thereby obtaining a mixed precipitate of cuprous oxide and basic cobalt carbonate. Compared with cupric oxide, when cuprous oxide and lithium source are calcined to prepare lithium cuprate, the required temperature is lower, and pure-phase lithium cuprate can be obtained. Therefore, in the subsequent high-temperature calcining of the cathode material, cuprous oxide is more conducive to the formation of lithium cuprate than divalent copper.

In the high-temperature calcining stage, first heating up in an inert atmosphere can melt the lithium source while avoiding the oxidation of cuprous oxide. Then, when the air/oxygen is subsequently introduced, the reaction is as follows:

4Co(OH)_{y}(CO₃)_{1-0.5y}+4LiOH+O₂→4LiCoO₂+(2+2y)H₂O+(4−2y)CO₂, and

2Cu₂O+8LiOH+O₂→4Li₂CuO₂+4H₂O.

The lithium cuprate (Li₂CuO₂) cathode material is a lithium-rich cathode material, which has higher theoretical specific capacity and theoretical energy density than other cathode materials, and can provide pre-lithiation capability for the obtained lithium cobalt oxide cathode material, further improving the discharge capacity of the cathode material.

In addition, there are [CuO₄] chains in the structure of lithium cuprate, which are arranged in a co-top manner and exist in a tetrahedron formed by the oxygen atoms with the Cu atom as the center. Such structure is relatively stable under high voltage, and it can also provide a channel for transferring lithium ions. During the charging and discharging process, lithium ions can enter and exit the [CuO₄] structures through the gap therebetween, thereby ensuring the stable structure and the normal charge and discharge of the cathode material simultaneously.

### BRIEF DESCRIPTION OF DRA WINGS

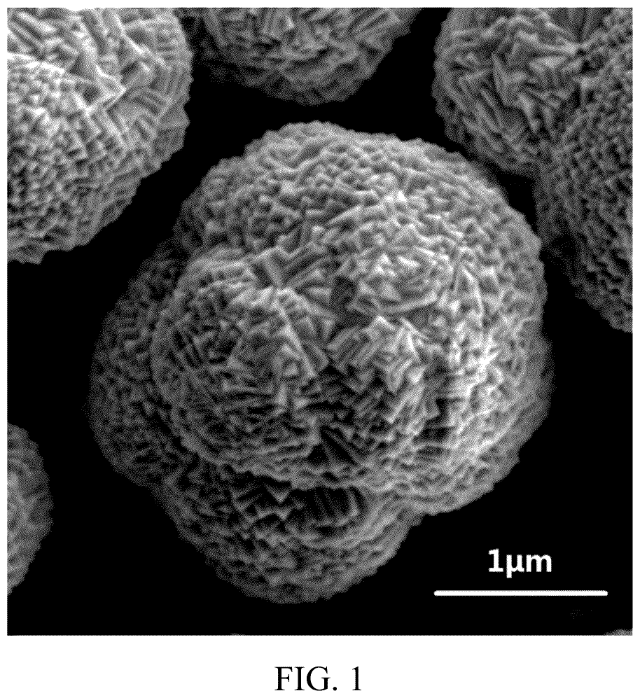

FIG. 1 is the SEM image of the copper-doped lithium cobalt oxide precursor prepared in Example 1 of the present invention; and

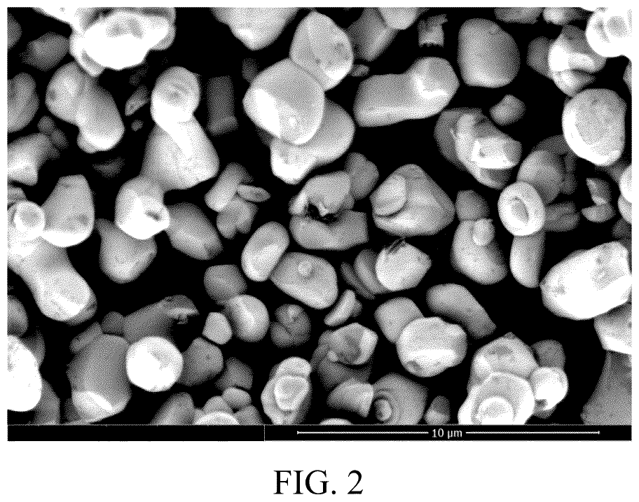

FIG. 2 is the SEM image of the cathode material prepared in Example 1 of the present invention.

### DETAILED DESCRIPTION

The present invention will be further described below with reference to specific examples.

### Example 1

A method for preparing a copper-doped lithium cobalt oxide precursor comprised the following steps:
(1) according to the molar ratio of cobalt element to copper element of 10:0.5, cobalt sulfate and copper sulfate were respectively selected as raw materials to prepare a solution of mixed salts with a total concentration of metal ions of 0.5 mol/L;
(2) the solution of mixed salts in step (1) was added into a hydrothermal reaction kettle with an addition amount of ⅗ of the volume of the reaction kettle;
(3) urea was added to the reaction kettle with a concentration of 2.0 mol/L;
(4) glucose was added into the reaction kettle with a molar quantity of 3 times that of copper element;
(5) the reaction kettle was sealed, then the mixture was heated and stirred at a heating temperature of 140° C. and a stirring speed of 150 r/min to react for 6 h; and
(6) after the reaction was completed, the reaction mixture was subjected to solid-liquid separation, the obtained solid product was washed with ethanol first, then with pure water, and then the washed product was dried at 100° C. for 3 hours to obtain a copper-doped lithium cobalt oxide precursor.

A copper-doped lithium cobalt oxide precursor was prepared by the above-mentioned method, and the SEM image of the copper-doped lithium cobalt oxide precursor was shown in FIG. 1.

A method for preparing a cathode material comprised the following steps: according to the molar ratio of cobalt element to lithium element of 1:1.3, the above-mentioned copper-doped lithium cobalt oxide precursor and lithium hydroxide were mixed, the mixture was heated under an inert gas with a heating rate of 10° C./min and a heating gradient from room temperature to 850° C., then air was introduced instead, the temperature was maintained for 15 h, and then the resulting mixture was crushed, sieved, and removed off iron to obtain a copper-doped lithium cobalt oxide cathode material.

A cathode material was prepared by the above-mentioned method, and the SEM image of the cathode material was shown in FIG. 2.

### Example 2

A method for preparing a copper-doped lithium cobalt oxide precursor comprised the following steps:
(1) according to the molar ratio of cobalt element to copper element of 10:1, cobalt chloride and copper chloride were respectively selected as raw materials to prepare a solution of mixed salts with a total concentration of metal ions of 1.0 mol/L;
(2) the solution of mixed salts in step (1) was added into a hydrothermal reaction kettle with an addition amount of ⅘ of the volume of the reaction kettle;
(3) urea was added to the reaction kettle with a concentration of 4.0 mol/L;
(4) fructose was added into the reaction kettle with a molar quantity of 4 times that of copper element;
(5) the reaction kettle was sealed, then the mixture was heated and stirred at a heating temperature of 160° C. and a stirring speed of 200 r/min to react for 4 h; and
(6) after the reaction was completed, the reaction mixture was subjected to solid-liquid separation, the obtained solid product was washed with ethanol first, then with pure water, and then the washed product was dried at 120° C. for 2 h to obtain a copper-doped lithium cobalt oxide precursor.

A copper-doped lithium cobalt oxide precursor was prepared by the above-mentioned method.

A method for preparing a cathode material comprised the following steps: according to the molar ratio of cobalt element to lithium element of 1:1.4, the above-mentioned copper-doped lithium cobalt oxide precursor and lithium carbonate were mixed, the mixture was heated under an inert gas with a heating rate of 5° C./min and a heating gradient from room temperature to 850° C., then oxygen gas was introduced instead, the temperature was maintained for 12 h, and then the resulting mixture was crushed, sieved, and removed off iron to obtain a copper-doped lithium cobalt oxide cathode material.

A cathode material was prepared by the above-mentioned method.

### Example 3

A method for preparing a copper-doped lithium cobalt oxide precursor comprised the following steps:
(1) according to the molar ratio of cobalt element to copper element of 10:0.01, cobalt sulfate and copper sulfate were respectively selected as raw materials to prepare a solution of mixed salts with a total concentration of metal ions of 0.05 mol/L;
(2) the solution of mixed salts in step (1) was added into a hydrothermal reaction kettle with an addition amount of ⅗ of the volume of the reaction kettle;
(3) urea was added to the reaction kettle with a concentration of 0.2 mol/L;
(4) galactose was added into the reaction kettle with a molar quantity of 2 times that of copper element;
(5) the reaction kettle was sealed, then the mixture was heated and stirred at a heating temperature of 120° C. and a stirring speed of 100 r/min to react for 8 h; and
(6) after the reaction was completed, the reaction mixture was subjected to solid-liquid separation, the obtained solid product was washed with ethanol first, then with pure water, and then the washed product was dried at 80° C. for 4 h to obtain a copper-doped lithium cobalt oxide precursor.

A copper-doped lithium cobalt oxide precursor was prepared by the above-mentioned method.

A method for preparing a cathode material comprised the following steps: according to the molar ratio of cobalt element to lithium element of 1:1.2, the above-mentioned copper-doped lithium cobalt oxide precursor and lithium carbonate were mixed, the mixture was heated under an inert gas with a heating rate of 8° C./min and a heating gradient from room temperature to 700° C., then oxygen gas was introduced instead, the temperature was maintained for 18 h, and then the resulting mixture was crushed, sieved, and removed off iron to obtain a copper-doped lithium cobalt oxide cathode material.

A cathode material was prepared by the above-mentioned method.

### Comparative Example 1: (Compared with Example 1, No Carbon Source was Added, and the Other Steps and Parameters were Exactly the Same as Those in Example 1)

A method for preparing a copper-doped lithium cobalt oxide precursor comprised the following steps:
(1) according to the molar ratio of cobalt element to copper element of 10:0.5, cobalt sulfate and copper sulfate were respectively selected as raw materials to prepare a solution of mixed salts with a total concentration of metal ions of 0.5 mol/L;
(2) the solution of mixed salts in step (1) was added into a hydrothermal reaction kettle with an addition amount of ⅗ of the volume of the reaction kettle;
(3) urea was added to the reaction kettle with a concentration of 2.0 mol/L;
(4) the reaction kettle was sealed, then the mixture was heated and stirred at a heating temperature of 140° C. and a stirring speed of 150 r/min to react for 6 h; and
(5) after the reaction was completed, the reaction mixture was subjected to solid-liquid separation, the obtained solid product was washed with ethanol first, then with pure water, and then the washed product was dried at 100° C. for 3 h to obtain a copper-doped lithium cobalt oxide precursor.

A copper-doped lithium cobalt oxide precursor was prepared by the above-mentioned method.

A method for preparing a cathode material comprised the following steps: according to the molar ratio of cobalt element to lithium element of 1:1.3, the above-mentioned copper-doped lithium cobalt oxide precursor and lithium hydroxide were mixed, the mixture was heated under an inert gas with a heating rate of 10° C./min and a heating gradient from room temperature to 850° C., then air was introduced instead, the temperature was maintained for 15 h, and then the resulting mixture was crushed, sieved, and removed off iron to obtain a copper-doped lithium cobalt oxide cathode material.

A cathode material was prepared by the above-mentioned method.

### Comparative Example 2: (Compared with Example 2, No Carbon Source was Added, and the Other Steps and Parameters were Exactly the Same as Those in Example 2)

A method for preparing a copper-doped lithium cobalt oxide precursor comprised the following steps:
(1) according to the molar ratio of cobalt element to copper element of 10:1, cobalt chloride and copper chloride were respectively selected as raw materials to prepare a solution of mixed salts with a total concentration of metal ions of 1.0 mol/L;
(2) the solution of mixed salts in step (1) was added into a hydrothermal reaction kettle with an addition amount of ⅘ of the volume of the reaction kettle;
(3) urea was added to the reaction kettle with a concentration of 4.0 mol/L;
(4) the reaction kettle was sealed, then the mixture was heated and stirred at a heating temperature of 160° C. and a stirring speed of 200 r/min to react for 4 h; and
(5) after the reaction was completed, the reaction mixture was subjected to solid-liquid separation, the obtained solid product was washed with ethanol first, then with pure water, and then the washed product was dried at 120° C. for 2 h to obtain a copper-doped lithium cobalt oxide precursor.

A copper-doped lithium cobalt oxide precursor was prepared by the above-mentioned method.

A method for preparing a cathode material comprised the following steps: according to the molar ratio of cobalt element to lithium element of 1:1.4, the above-mentioned copper-doped lithium cobalt oxide precursor and lithium carbonate were mixed, the mixture was heated under an inert gas with a heating rate of 5° C./min and a heating gradient from room temperature to 850° C., then oxygen gas was introduced instead, the temperature was maintained for 12 h, and then the resulting mixture was crushed, sieved, and removed off iron to obtain a copper-doped lithium cobalt oxide cathode material.

### Comparative Example 3: (Compared with Example 3, No Carbon Source was Added, and the Other Steps and Parameters were Exactly the Same as Those in Example 3)

A method for preparing a copper-doped lithium cobalt oxide precursor comprised the following steps:
(1) according to the molar ratio of cobalt element to copper element of 10:0.01, cobalt sulfate and copper sulfate were respectively selected as raw materials to prepare a solution of mixed salts with a total concentration of metal ions of 0.05 mol/L;
(2) the solution of mixed salts in step (1) was added into a hydrothermal reaction kettle with an addition amount of ⅗ of the volume of the reaction kettle;
(3) urea was added to the reaction kettle with a concentration of 0.2 mol/L;
(4) the reaction kettle was sealed, then the mixture was heated and stirred at a heating temperature of 120° C. and a stirring speed of 100 r/min to react for 8 h; and
(5) after the reaction was completed, the reaction mixture was subjected to solid-liquid separation, the obtained solid product was washed with ethanol first, then with pure water, and then the washed product was dried at 80° C. for 4 h to obtain a copper-doped lithium cobalt oxide precursor.

A copper-doped lithium cobalt oxide precursor was prepared by the above-mentioned method.

A method for preparing a cathode material comprised the following steps: according to the molar ratio of cobalt element to lithium element of 1:1.2, the above-mentioned copper-doped lithium cobalt oxide precursor and lithium carbonate were mixed, the mixture was heated under an inert gas with a heating rate of 8° C./min and a heating gradient from room temperature to 700° C., then oxygen gas was introduced instead, the temperature was maintained for 18 h, and then the resulting mixture was crushed, sieved, and removed off iron to obtain a copper-doped lithium cobalt oxide cathode material.

A cathode material was prepared by the above-mentioned method.

### Test Example:

The cathode materials obtained in Examples 1-3 and Comparative Examples 1-3 were used as an active material, acetylene black was used as a conductive agent, and PVDF was used as a binding agent. The active material, the conductive agent, and the binding agent were weighed in a ratio of 92:4:4, and added with a certain amount of organic solvent NMP, and the mixture was stirred. The resulting mixture was coated on aluminum foil to make a positive electrode sheet, and a metal lithium sheet was used as the negative electrode. A CR2430 button battery was made in a glove box filled with argon gas. The electrical performance test was conducted in CT2001A LAND test system. Test conditions: 3.0-4.48 V, current density 1 C=180 mAh/g, and test temperature 25±1° C. The test results were shown in Table 1 below.

### Table 1: Results of Electrical Performance Test of Battery

TABLE 1
Results of electrical performance test of battery

| | Discharge | Capacity |
|---|---|---|
| | capacity | retention rate after |
| | mAh/g at 0.1 | 600 cycles at |
| | C/4.48 V | 0.1 C/4.48 V |
| Example 1 | 232.3 | 88.3% |
| Example 2 | 248.6 | 84.6% |
| Example 3 | 219.4 | 87.2% |
| Comparative | 215.2 | 77.2% |
| Example 1 | | |
| Comparative | 220.4 | 72.3% |
| Example 2 | | |
| Comparative | 209.7 | 79.8% |
| Example 3 | | |

It can be seen from Table 1 that the cathode materials prepared by the copper-doped lithium cobalt oxide precursors prepared by the present invention had superior discharge capacity and cycle stability, wherein the discharge capacity thereof was 219.4 mAh/g or more, and the capacity retention rate after 600 cycles thereof was 84.6% or more. In addition, comparing Example 1 with Comparative Example 1, Example 2 with Comparative Example 2, and Example 3 with Comparative Example 3, respectively, it can be seen that when no carbon source was added in the hydrothermal reaction during the preparation of the copper-doped lithium cobalt oxide precursor, the cycle stability and discharge capacity of the finally prepared cathode material decreased.

The above-mentioned examples are preferred embodiments of the present invention, but the embodiments of the present invention are not limited by the above-mentioned examples, and any other changes, modifications, substitutions, combinations, and simplification made without departing from the spirit and principle of the present invention should be equivalent replacement modes, which are included within the protection scope of the present invention.

1. A method for preparing a copper-doped lithium cobalt oxide precursor, comprising the following steps:
(1) mixing a solution of soluble cobalt salt and copper salt, urea and a carbon source to perform a hydrothermal reaction to obtain a mixture; and
(2) subjecting the mixture obtained in step (1) to solid-liquid separation, washing and drying the obtained solid product to obtain the copper-doped lithium cobalt oxide precursor.

2. The method for preparing a copper-doped lithium cobalt oxide precursor according to claim 1, wherein a total concentration of metal ions in the solution of soluble cobalt salt and copper salt is 0.01-1.5 mol/L, and a molar ratio of cobalt element to copper element is 10:(0.01-2).

3. The method for preparing a copper-doped lithium cobalt oxide precursor according to claim 1, wherein a concentration of the urea is 0.1-5.0 mol/L.

4. The method for preparing a copper-doped lithium cobalt oxide precursor according to claim 2, wherein a molar quantity of the carbon source is 1.5-6 times that of the copper element.

5. The method for preparing a copper-doped lithium cobalt oxide precursor according to claim 1, wherein a temperature for the hydrothermal reaction in step (1) is 100-200° C., and a duration for the reaction is 1-10 h.

6. A copper-doped lithium cobalt oxide precursor, which is prepared by the method according to claim 1.

7. A method for preparing a cathode material, comprising the following steps: mixing the lithium cobalt oxide precursor according to claim 6 with a lithium source, and then calcining a resulting mixture to obtain the cathode material.

8. The method for preparing a cathode material according to claim 7, wherein the calcining is conducted by first heating the resulting mixture under the protection of an inert gas with a heating rate of 3-15° C./min and a heating gradient from room temperature to 600-900° C., then introducing an oxidizing gas instead, and maintaining at 600-900° C. for 10-20 h.

9. A cathode material, which is prepared by the method according to claim 7.

10. Use of the cathode material according to claim 9 in a lithium ion battery.

11. A copper-doped lithium cobalt oxide precursor, which is prepared by the method according to claim 2.

12. A copper-doped lithium cobalt oxide precursor, which is prepared by the method according to claim 3.

13. A copper-doped lithium cobalt oxide precursor, which is prepared by the method according to claim 4.

14. A copper-doped lithium cobalt oxide precursor, which is prepared by the method according to claim 5.

15. A method for preparing a cathode material, comprising the following steps: mixing the lithium cobalt oxide precursor according to claim 11 with a lithium source, and then calcining a resulting mixture to obtain the cathode material.

16. A method for preparing a cathode material, comprising the following steps: mixing the lithium cobalt oxide precursor according to claim 13 with a lithium source, and then calcining a resulting mixture to obtain the cathode material.

17. The method for preparing a cathode material according to claim 15, wherein the calcining is conducted by first heating the resulting mixture under the protection of an inert gas with a heating rate of 3-15° C./min and a heating gradient from room temperature to 600-900° C., then introducing an oxidizing gas instead, and maintaining at 600-900° C. for 10-20 h.

18. The method for preparing a cathode material according to claim 16, wherein the calcining is conducted by first heating the resulting mixture under the protection of an inert gas with a heating rate of 3-15° C./min and a heating gradient from room temperature to 600-900° C., then introducing an oxidizing gas instead, and maintaining at 600-900° C. for 10-20 h.

19. A cathode material, which is prepared by the method according to claim 8.

20. Use of the cathode material according to claim 19 in a lithium ion battery.
